(19) United States
(12) Patent Application Publication
(10) Pub. No.: US 2010/0314196 A1
(43) Pub. Date: Dec. 16, 2010

(54) FALL PROTECTION RAIL AND PROTECTION METHOD

(76) Inventor: Walter De Boeck, Ponet (FR)

Correspondence Address: JORDAN AND HAMBURG LLP, 122 EAST 42ND STREET, SUITE 4000, NEW YORK, NY, 10168, US

(21) Appl. No.: 12/735,512

(22) PCT Filed: Jan. 22, 2009
(86) PCT No.: PCT/EP2009/000371

§ 371 Date: Sep. 2, 2010

(30) Foreign Application Priority Data
Jan. 23, 2008 (BE) 2008/0047

(51) Int. Cl. A62B 35/00; F16B 45/02

(52) U.S. Cl. 182/3; 24/599.1

(57) ABSTRACT

A fall prevention system with a securing point, in which the recess which accommodates the securing means and/or the recess which accommodates an external securing means can be locked and in which the lock can be actuated by keys on the securing means and/or on the external securing means. Also disclosed is an associated fall prevention method and the use of the fall prevention system.

The invention relates to a fall prevention system for objects which have to cover routes while at risk of falling, as what is known as a travelling fall prevention system. The invention likewise relates to a fall prevention method for the said objects.

It is generally known that objects which have to cover routes while at risk of falling can be secured from falling with a connecting means to a securing means which runs parallel to the route. Fall prevention systems of this type are known for example from buildings, ships, vie ferrate, high rope courses and training areas for sporting, mountaineering or military purposes. The fall prevention systems must conform to the specifications of European Standard EN 15567, which requires that the fall prevention system must be in place during the entire residence time in regions with a risk of falling.

This requirement however results in contradictions between technical necessities and economic specifications, for which reason different proposed solutions have been made in the meantime for technically realising this specification.

Generally, a securing means which runs parallel to a route must be supported at certain intervals. If a connecting means according to EN 15567 is connected to this securing means, for example by means of a securing point in the form of a ring or a carabiner hook, the anchoring points cannot be overcome without opening and removing the securing point and thereby making the existing fall prevention system ineffective.

According to a proposal in WO 2008/049143 A1, two carabiner hooks which are coupled to each other should solve the above-described problem. A v- or y-shaped connecting means is connected to two carabiner hooks towards the securing means, and both carabiner hooks are coupled to each other mechanically, fluidically, electrically, optically or by radio in such a manner that they reciprocally lock and unlock each other. If the gate of one carabiner hook is opened, the second carabiner hook is blocked. Consequently, it cannot be taken off the securing means.

This solution however has the disadvantage that a carabiner hook can be opened and taken off the securing means and then closed again without it being hung onto a securing means again. In this state, the blocking of the second carabiner hook is however lifted, so that this can also be opened and taken off the securing means. There is then no longer a fall prevention system and the requirement of EN 15567 is not met.

Such reciprocal blocking has already been proposed for tractors which are moved on the securing means in DE 10 2006 010 898 A1.

According to a further proposal in WO 2008/049143 A1, the above-described form of a connecting means is at the same time encrypted by electronic coding in such a manner that the existence of a direct connection to a securing means is established and monitored and that the blocking of the carabiner hook can only be removed when the object or the connecting means is situated in a region without any risk of falling or a region with differently equipped securing means. This proposal requires increased outlay on installation due to the necessary additional electrical and electronic devices, is cost-intensive and can only be used to a limited extent for retrofitting existing securing means and secured routes.

Proposals are also known which are intended to ensure that the securing point can be moved over the anchoring point without having to take it off.

One embodiment of the anchoring points simply uses a loose guide of the securing means with a form fit at the anchoring point. According to a proposal in EP 0 486 411 A1, this is a retaining means with antler-shaped spirals on two sides. Although there is the advantage in this case that the connecting means is provided with a conventional carabiner hook and this can be threaded through the antler-shaped spirals, it is disadvantageous that the anchoring point must be configured as a forged part, that not every size or shape of carabiner hook can be used, as well as the relatively difficult procedure when overcoming the anchoring points. Furthermore, it is not possible to continue without interrupting the fall prevention at the end points of the securing means.

A further proposal according to FR 2 775 605 A1 provides slotted anchoring points, with which the securing point (tractor) must be guided through the slot of the anchoring point. In this case solid components must be provided for the anchoring points and the securing points must have a slimline shape owing to the principle, as a result of which they are very restricted in terms of material selection and thus become cost-intensive. This proposal does not offer any solution for securing points in the form of rings or carabiner hooks.

Fall prevention systems are also known which ensure continuous progress without the necessity of changing over the securing points. Generally, highly tapered mountings are used for the securing means, over which mountings a tractor can pass, as proposed in EP 1 733 763 B1 or DE 10 2008 006 611 A1. Devices which operate with what is known as a tractor are also contained in US 2006/0090960 A1 and GB 0272 782 A1. In the field of the necessary anchoring points, solutions are configured which allow the respective tractors to pass over the anchoring points. The most essential disadvantage of this type of fall prevention system is the considerable material outlay and the lack of interchangeability between the tractors, the respective securing means and the anchoring points. This results to a considerable extent in problems if further securing means branch off from an existing securing means, the direction of the securing means changes, or for example there are obstacles in the course of the securing means.

It is therefore the object of the invention to propose a fall prevention system which can be produced with little outlay, is light, can be used universally and can be used in particular on already existing securing means. It is furthermore an object of the invention to propose a fall prevention method in which the fall prevention system is used and in which anchoring points are overcome without removing the fall prevention system.

These objects are achieved for the fall prevention system by the features of Patent claim 1, and for the fall prevention method by the features of claim 8. Independent and dependent claims likewise relate to particular embodiments of the fall prevention system or of the fall prevention method.

In the description of the invention below, the used terms are used with the following meanings:
Securing means—is a means with a defined cross section which is stretched at least between a first, a second and where necessary further anchoring points. In this case the securing means is usually a rope, a line, a cable, a pipe, a metal profile or a rail.
Anchoring point—is a fixed point at which the securing means is connected to a base.
Base—is anything which can hold an anchoring point permanently. This is usually a wall, rock, a building, a roof, a mast, a tree or scaffolding.
Securing point—is a unit which can be moved between two anchoring points on the securing means and can be separated from the securing means under certain conditions. This is often a carabiner hook or a ring.
Connecting means—is a means with a defined cross section which connects the securing point to an object, with parameters conforming to EN 15567. This is usually a rope, a chain, a rod or what is known as a climbing harness.
Object—is a person, a load, a safety harness, belt or vest.
Additional or external securing means—is a means which is arranged close to an anchoring point and can be connected to the securing point.
Lock—is the entirety of the means which allows the locking of the securing point to be lifted, the securing point to be made removable from the securing means and a new lock to be established after overcoming an anchoring point and connecting again to a securing means.
Key—is a means which is available in the vicinity of an anchoring point and allows the lock of the securing point to be operated.

According to the invention, a fall prevention system, in which a mobile (travelling) securing point can be moved over a securing means, in which the locking state of the securing point is likewise visible and to which an external securing means is attached, is connected to a securing means in such a manner that the parts of the securing point which can be opened are locked and unlocking is only possible with a key.

According to the invention, a fall prevention system is used in particular with a securing means which runs between at least one first and one second anchoring point to a base, with it being impossible for the mobile (travelling) securing point to overcome the anchoring points, as it completely surrounds the securing means. An additional external securing means or a key are arranged in the vicinity of the anchoring points of the securing means in such a manner that they can be attached to the mobile (travelling) securing point. The existing lock is unlocked and the securing point can be removed from the securing means. At the same time, the attached additional external securing means locks with the securing point or with an additional key so that fall prevention remains guaranteed without changing the safety level.

It is only possible to unlock the securing point by attaching the additional external securing means. The latter is therefore designed in such a manner that the components which are involved in connecting the two units are designed so as to correspond to each other, and at the same time as the attachment locking takes place, which can only be unlocked again by the parts of the securing point which surround the securing means being closed and locked.

The locking of the surrounding parts of the securing point and of the corresponding parts of the securing point with the additional external securing means are mutually dependent, that is, one lock must always be closed.

As the additional external securing means is arranged in the vicinity of an anchoring point, an approaching (travelling) securing point can be removed by attaching the additional external securing means and hung again in the securing means on the other side of the anchoring point. After the surrounding means of the securing point have been closed and locked, the additional external securing means can be removed.

The mobile (travelling) securing point has at least one unit which surrounds the securing means. The surrounding unit can be opened in at least one part region, with the opening being secured by a locking unit which can be unlocked. This part region is unlocked and opening of the surrounding unit is possible only by attaching an additional external securing means.

A preferred embodiment for a mobile (travelling) securing point is a carabiner hook with a locking unit for the gate (barrel). The locking unit is a component of the carabiner, and the docking additional external securing means acts virtually as a key for unlocking the lock of the carabiner on the one hand and for securing the removed securing point on the other hand.

The object to be secured can be a person, a load, a safety harness, a safety belt or a safety vest.

The base which bears the anchoring points can be anything which can hold an anchoring point permanently. This is usually a wall, rock, a building, a roof, a mast, a tree or scaffolding.

The securing means can be part of a securing system in the region of a base. It can be part of a training course, what is known as a high rope course or a climbing garden.

The connecting means between the mobile (travelling) securing point and the object can be a rope, a chain, a belt or a loop.

The additional external securing means can be arranged in the vicinity of an anchoring point in a fixed or mobile manner or provided with a section of an additional securing means. One of the attachment types is used depending on the configuration of the anchoring points and the local conditions.

The generally preferred type of attachment is that with an additional section of a securing means, with the latter being fixed near to the anchoring point with one end while the other end with the locking unit or the key can be moved to a limited extent.

The above-described form of the arrangement allows an approaching mobile (travelling) securing point to be changed over over a somewhat greater distance without the object to be secured being without protection.

A further embodiment of the mobile (travelling) securing point has an approximately disc-shaped design with a circular, oval or polygonal outline. There is a metal ring in a channel inside the disc-shaped housing, which metal ring can be displaced and locked. In the housing at least one first recess is provided which can be locked by the displaceable metal ring. A second recess is used to attach the connecting means.

Inside the metal ring there is a pin which leads through the centre, can be displaced laterally and can engage in recesses in the metal ring. The pin is guided in a channel in the housing. Approximately centrally it has grooves in which a rocker switch and coding slides engage. The rocker switch and coding slides are fixed with a resilient contact block in one position in which they fix the pin in a predefined axial position. The housing has a bore for introducing a key approximately in the region of the opposite end of the rocker switch. If the key is introduced as far as the stop, it touches the end of the rocker switch, moves it, lifts up the lock, and the coding slides are pressed against additional springs, as a result of which the pin is displaced into another axial position. The arresting of the metal ring is thus lifted so that the metal ring can be displaced in its guide. The recess can thus be opened and the securing point can be removed from the securing means.

The key is normally designed in such a manner that it can reliably transmit the forces which arise with a fall prevention system and is also arranged close to an anchoring point. The removed securing point is thereby secured until connected again to the securing means by the key and the latter is fixed.

The generally preferred embodiment of the disc-shaped securing point has a further recess to be opened which can likewise be locked by the metal ring. The securing point preferably has a symmetrical structure. The first recess is used to connect to the securing means, whereas the further recess is used to connect to an additional external securing means. The locking device is configured in such a manner that it has two defined switch positions which in each case can be switched with a key. The securing means also bears a key which, after the securing point is connected, together with the latter switches the locking device into a position in which the metal ring has locked the corresponding recess and the pin can engage in a recess of the metal ring and fix the latter in the assumed position. If the metal ring has not reached this position and if for example the recess is not open, the corresponding switch position cannot be reached. The key is configured in such a manner that it is fixed in the locking device until the coding slides are returned to their starting position. This is only possible when the metal ring has assumed its target position.

The opposite recess is at the same time opened by the displacement of the metal and the external securing means which has been locked until now can be removed.

The configuration of the securing point allows the metal ring to be moved within certain angle ranges without impairing the function of the securing device. To achieve this, in one embodiment the fixing of the position can take place in such a manner that the pin engages with its ends in slots, grooves or recesses with a similar effect in the metal ring, as a result of which the latter remains rotatable to a limited extent. This makes a rotary movement of the metal ring possible in such a manner that, when one recess is closed and locked, the respective other recess is opened.

One embodiment of the securing point provides additional handles on the metal ring, which make rotating the metal ring easier.

A further embodiment of the securing point provides the additional arrangement of coatings on the housing of the securing point in order to improve its haptic properties.

A further embodiment of the securing point likewise provides a disc-shaped component which has an approximately polygonal outer contour. The openings of the first and the second recess are opened or closed by an angle lever each. The long limb is used for this in each case, whereas the short limb of the angle lever is guided with a pin in an arc-shaped recess in the housing, as a result of which the movement of the angle lever is at the same time limited. A locking unit is in turn arranged approximately in the centre, which moves a pin into defined switch positions as described above. In this embodiment of the securing point, the ends of the pin are displaced into the arc-shaped recesses, as a result of which the angle lever can be locked in the closing position. The lock is produced in that the displaceable pin prevents a movement of the pin of the angle lever in the arc-shaped recess.

The locking unit is operated as described above with at least one or preferably two keys and effects the positioning of the pin which is necessary in each case by being operated, and, as a consequence of this, the locking of the opening of one of the two recesses by the respective angle lever, with the locking always taking place reciprocally. The reciprocal locking is also effected in that the long limb, which is turned inwards, of the angle lever covers in each case the introduction opening of the key in the housing in this position, so that a key can only be introduced when the respective securing means is in the recess, the angle lever closes the opening of the recess and at the same time is in the locking position.

A device is provided at the front end of the long limb of the angle lever, which device makes possible a form-fitting connection with respect to the bracket of the housing. The bracket is reinforced in the transition region of the housing centre part in the bracket, with it likewise being possible for the reinforcement to be an additionally arranged component as well as an integral connection. This is likewise possible for the corresponding parts between the end of the bracket and the end of the angle lever.

The angle levers can be returned to a target position, which will preferably be the closed position, by spring force. It is thus ensured that in this embodiment of the securing point the recesses are always closed, with the locking unit effecting the required locking of one of the two angle levers when actuated by means of the respective movement of the pin into the necessary target position.

The preferred embodiment of the described securing points provides for the keys which are present on the securing means or on the external securing means to be coded differently and thus for misuse to be ruled out. This can also be supported by the length and attachment of the key and the location of the attachment.

The fall prevention method which is to be carried out according to the invention for overcoming a fixed anchoring point on a securing means by means of a mobile (travelling) securing point consists in that, when the anchoring point is reached, an additional external securing means which is arranged there is attached to the securing point. At the same time as the attachment, a lock which is active in the securing point is unlocked so that the components of the securing point which surround the securing means can be opened and the securing point can be removed from the securing means.

At the same time as the attachment of the additional external securing means, the locking takes place between the securing point and the additional external securing means. The securing point can then be changed over to the other side of the anchoring point, to another securing means or also to a fixed point. When the surrounding components of the securing point are subsequently closed, they are locked again and at the same time the locking of the attached additional external securing means is lifted. The additional external securing means is subsequently removed.

The described method is applicable to securing points which are configured as lockable carabiners or to analogous embodiments with comparable functionality.

Another configuration of the fall prevention method requires that an element for actuating the lock of the securing point is additionally present on the securing means at the anchoring point.

The securing point approaching an anchoring point is connected to an element which is suitable for actuation, affects the lock of the securing point and at the same time assumes the task of externally securing the securing point to be removed. With a second element, which is situated on the securing means and likewise affects the lock, the locking of the surrounding components which has existed until now is lifted and at the same time the locking of the additional external securing means is effected. The additional means is removed again after actuating the lock.

After the securing point has been changed over, the original state is restored with a further component which affects the lock and is in turn situated on the securing means by actuating the lock again, with this only being possible when the components of the securing point which surround the securing means have previously been closed. The original state of the lock is restored and the attached additional external securing means is unlocked by actuating the lock again and removing the external means. The additional external securing means can then be removed, and there is a new fall prevention system on a securing means.

A further configuration of the fall prevention method is based on a securing point with separate recesses for the securing means and the additional external securing means.

The securing point approaching the anchoring point of the securing means allows the opening of the recess in order to accommodate the additional external securing means. The additional external securing means is hung with a ring or a loop, the recess is closed and, with the aid of a key which is fixed to the ring or the loop, the locking mechanism in the securing point is brought into a switch position in which the recess for the additional external securing means is locked and the recess for the securing means is opened. After the removal of the securing point and the changeover, the recess for the securing means is closed again. With a key which is present on the securing means, the lock of the securing point is brought into a switch position in which the recess for the securing means is locked, while the recess for the additional external securing means is opened. After this recess is opened the additional external securing means can be removed.

In this configuration of the fall prevention method, the lock in the securing point can only be set with the corresponding coded key and misuse and inappropriate use of the securing point can be excluded.

The invention is used according to its intended use for securing objects where there is a risk of falling.

A preferred form of the use is fall prevention on buildings, ships, vie ferrate, high rope courses and training areas for sporting, mountaineering or military purposes.

The invention therefore has the advantage that it makes possible simple and cost-effective securing of an object with a connecting means to a securing means and in the process no or only slight efforts for retrofitting existing fall prevention systems are necessary. The fall prevention method has the advantage that continuous securing of the object is possible despite the necessary changeover at fixed anchoring points.

The invention is described in more detail below using exemplary embodiments and drawings. In the figures:

FIG. 1—shows an embodiment of a carabiner hook which can be unlocked by an additional component.

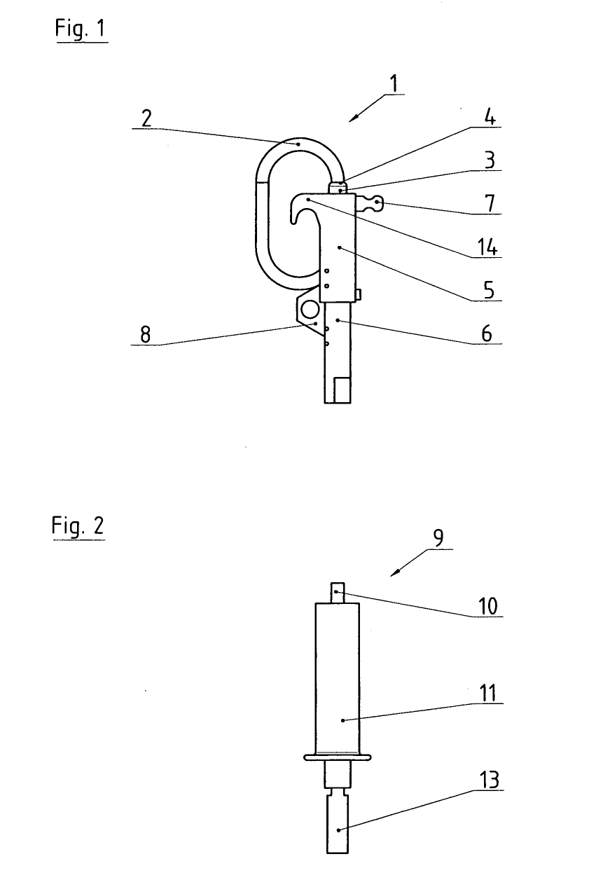

FIG. 2—shows an embodiment of the component necessary for unlocking the carabiner hook.

FIG. 3—shows a securing point in a disc-shaped configuration in the normal arrangement.

FIG. 4—shows the same disc-shaped securing point with an additionally arranged external securing means.

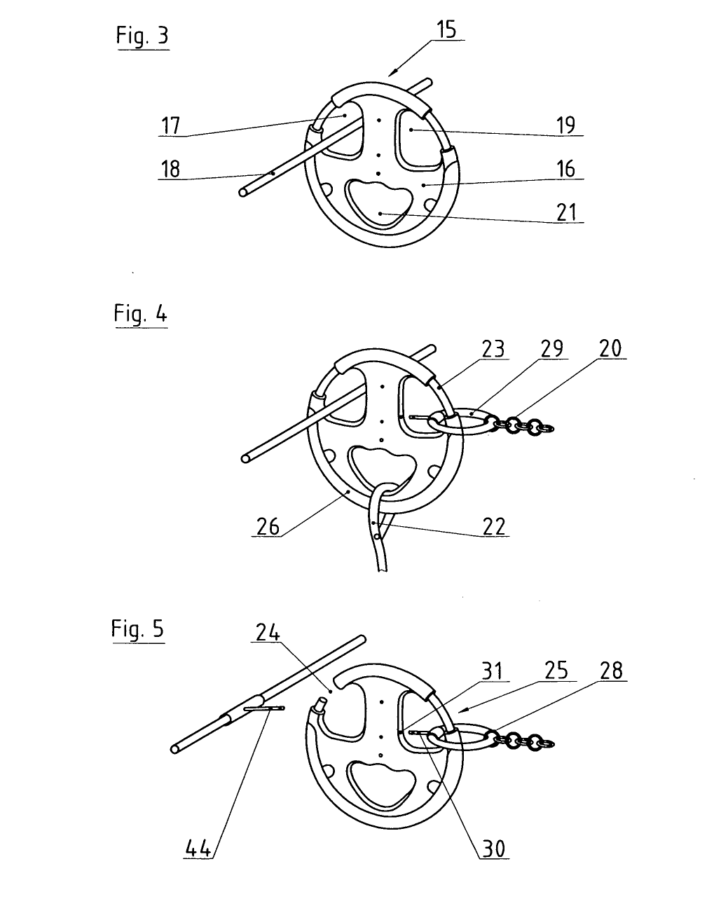

FIG. 5—shows the same disc-shaped securing point in a situation in which the connection to the securing means is disconnected.

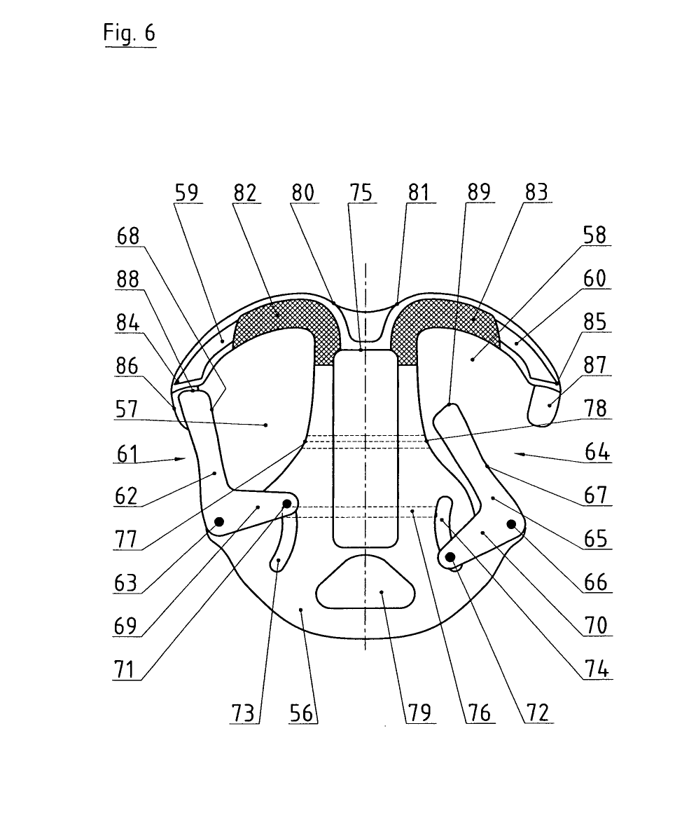

FIG. 6—shows a disc-shaped securing point which operates with angle levers as the closure elements.

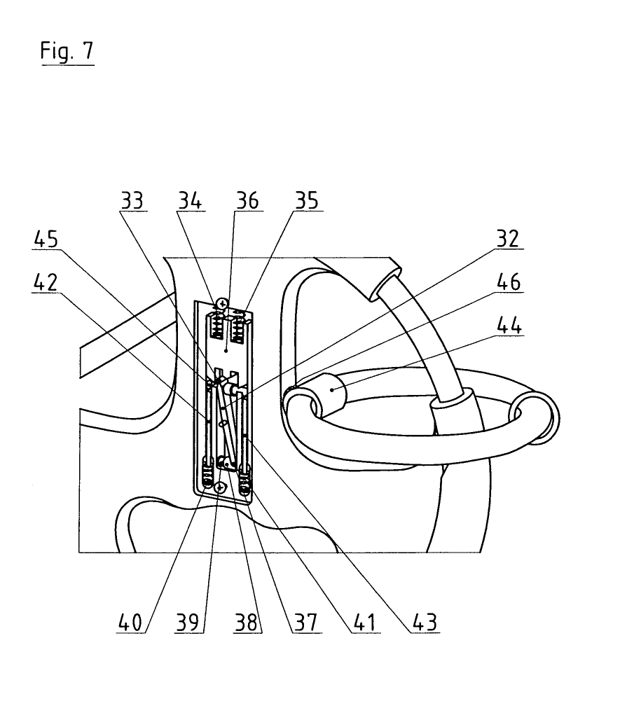

FIG. 7—shows a schematic diagram of the locking device of the disc-shaped securing point in one switch position.

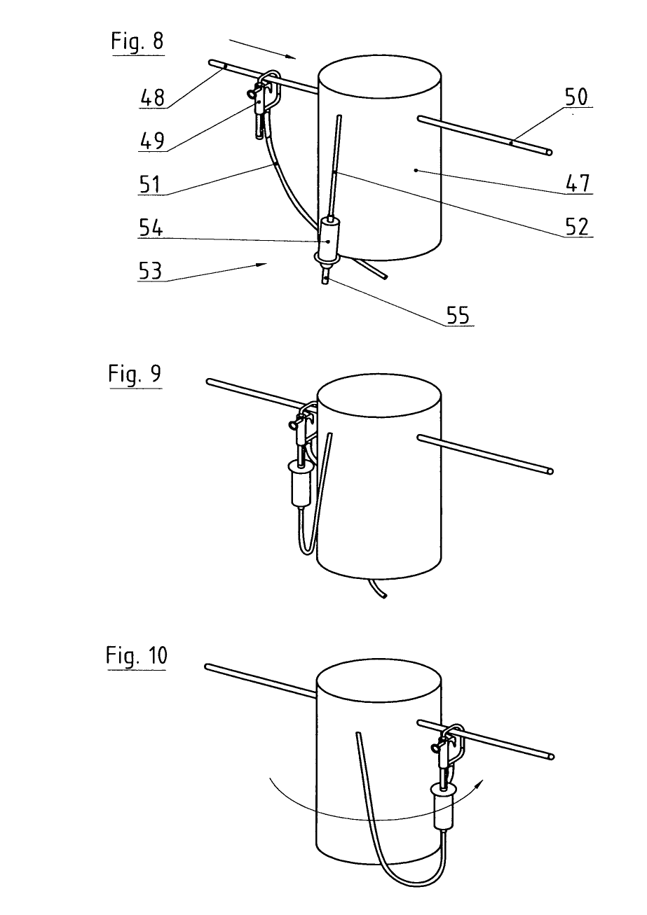

FIG. 8—shows a schematic diagram of the state when a securing point approaches an anchoring point.

FIG. 9—shows a schematic diagram of the docking of the additional external securing means on the securing point.

FIG. 10—shows a schematic diagram of the situation after changing over the securing point before removing the additional external securing means.

A carabiner hook 1 consists of a bracket 2, which is approximately circular or oval and has a cylindrical attachment 3, with the aid of which a linear movement of part of the bracket 2 is possible. The carabiner hook 1 can thereby be opened at the disconnection point 4. The cylindrical attachment 3 is contained in a housing 5 which also has a handling element 6. In the extension of the cylindrical attachment 3 there is a fixing part 7, by means of which the housing 5 can be pushed. At the same time it bears a lug 8 which is used to connect to any kind of connecting means.

The docking unit 9 consists of a compatible section (key) 10 for connecting to the cylindrical attachment 3 of the carabiner hook 1, a handle 11 and a lug 13 for connecting to the additional external securing means.

When docking on the carabiner hook 1, the compatible section 10 is first introduced into a recess and rotated here by a certain angle. The carabiner hook 1 is unlocked in the process and can be opened.

The closing of the carabiner generally takes place in such a manner that a hook-shaped projection 14 on the housing 5 is hung into the securing means so that first the carabiner hook 1 is closed by axial tension on the cylindrical attachment 3. The compatible section 10 is turned back by a certain angle using the handle 11. The docking unit is thereby freed and can be removed from the cylindrical attachment 3. The connection to the additional external securing means is thus separated and at the same time a locked connection to a securing means is produced. Fall prevention exists in all of the described states.

Equivalent fall prevention can be achieved with a conventional carabiner hook, the gate (barrel), closure or clamping unit of which is supplemented by a locking unit with the above-described functionality.

A securing point 15 in a disc-shaped embodiment with a circular contour has a housing 16 with a first recess 17 for accommodating a securing means 18, a second recess 19 for accommodating an additional external securing means 20 and a third recess 21 for producing a connection with a connecting means 22 for securing the object.

A metal ring 23 is guided inside the housing 16, which metal ring can reciprocally open the openings 24 and 25 of the first recess 17 and the second recess 19 by being moved into certain switch positions.

To facilitate the movement of the metal ring 23, an actuation element (not shown) can also be arranged. The housing 16 can likewise have additional coatings 26 with improved haptic properties.

At least the additional external securing means 20, which has a metal ring 29 at its end 28, bears a key 30 which can be inserted into a bore 31 in the housing 16 of the securing point 15. With this key 30 a locking device is actuated in such a manner that the metal ring 23 is released and can execute a movement by means of which first the opening 25 of the second recess 19 can be closed and the opening 24 of the first recess 17 can be opened. It is thus possible to remove the securing point 15 from the securing means 18 while it is still secured by means of the additional external securing means 20.

One embodiment of the locking device consists of a rocker switch 32 which is mounted such that it can rotate on an axis in the housing 16 of the securing point 15 and is held with its upper end 33 in predefined positions by means of a cam disc 36 which is loaded with springs 34 and 35 and is connected with its lower end 37 in an articulated manner to a pin 38 which runs transversely to the metal ring 23 and through its centre. The pin 38 has a plurality of grooves 39 in which coding slides 42 and 43, which are loaded by springs 40 and 41, can latch. The coding slides 42 and 43 are at the same time in contact with keys 30 and 44, which can be introduced into a bore 45 and 46 present in the housing 16.

Depending on which key 30 or 44 is inserted, the rocker switch 32 is moved into a switch position, while moving the pin 38 in a linear manner at the same time. To be able to achieve this, the rocker switch 32 presses the cam disc 36 with its upper end 33 against the springs 34 and 35 and lifts it. The introduced key 30 or 44 presses the respective coding slides 42 or 43 downwards against the spring 40 or 41 and this allows the pin 38 to be released for the desired linear movement. If this movement is executed, the metal ring 23 can be moved in the housing 16 by a certain angle, with the possible movement being limited by recesses (not shown) in the metal ring 23 and the pin 38 engaging in these recesses.

A securing point with an approximately polygonal outer contour consists of a housing 56 into which a first recess 57 and a second recess 58 have been made. In the extension of the housing 56, the recess 57 is additionally surrounded by a first bracket 59 and the second recess 58 is surrounded by a second bracket 60. The opening region 61 of the first recess 57 is closed by an angle lever 62 which is mounted in the point 63, and the opening region 64 of the recess 58 is closed by an angle lever 65 which is mounted in the point 66. The long limbs 67 and 68 of the angle levers 62 and 65 in each case close the opening regions 61 and 64. The short limbs 69 and 70 run with pins 71 and 72 in arc-shaped recesses 73 and 74, as a result of which a rotating angle limitation is produced.

A locking device 75 is arranged in the housing 56 of the securing point, which device moves a pin 76 which is situated in the housing 56 and is illustrated in FIG. 6 with dashed lines by means of rocker switches and coding slides as described above, with the locking unit 75 producing a movement of the rocker switch by actuation with the aid of keys which are inserted into the introduction openings 77 or 78 and with the pin 76 at the same time being displaced into one of its target positions.

In FIG. 6 the angle lever 62 is shown in the closed position whereas the angle lever 65 is shown in the open position. The angle lever 62 is at the same time locked by the pin 76 which blocks the pin 71.

A recess 79 for attaching a connecting means is also arranged in the housing 56 of the securing point.

The brackets 59 and 60 are reinforced in the transition region 80, 81 by inserts 82, 83. Elements 86, 87 are integrally formed on their ends 84, 85, which produce a form-fitting connection in conjunction with compatible elements on the ends 88, 89 of the angle levers 62, 65. At the same time, unintentional opening of the brackets 59 and 60 in the event of overloading is thus prevented.

The fall prevention system is used in the manner described below. A securing means 48 is fixed to an anchoring point 47. The anchoring point 47 only has to be an obstacle which the approaching mobile (travelling) securing point 49 cannot overcome. It does not matter whether the securing means 48 goes through the anchoring point 47, whether it ends at the anchoring point 47 or whether one or a plurality of securing means 50 continue from the anchoring point 47.

The approaching mobile (travelling) securing point 49 is locked and there is an attachment of a connecting means 51 to an object (not shown). A docking unit 53 is fixed to the anchoring point with an additional external securing means 52, which docking unit has, in addition to a handle 54, compatible elements 55 for connecting and unlocking the mobile (travelling) securing point 49. The additional external securing means 52 is connected to the mobile (travelling) securing point 49, with the latter being unlocked, making it possible to open it. At the same time a lock is produced between the mobile (travelling) securing point 49 and the compatible elements 55, which assume the task of fall prevention after the mobile (travelling) securing point 49 has been opened. The mobile (travelling) securing point 49 can then be changed over to a continuing securing means 50 and, once the mobile (travelling) securing point 49 has been closed, the lock of the compatible elements 55 can be opened again, with the mobile (travelling) securing point 49 locking itself at the same time. The additional external securing means 52 can then be removed and the mobile (travelling) securing point 49 can be moved further on the securing means 50.

### LIST OF REFERENCE SYMBOLS

1 Carabiner hook
2 Bracket
3 Cylindrical attachment
4 Disconnection point
5 Housing
6 Handling element
7 Fixing part
8 Lug
9 Docking unit
10 Compatible section (key)
11 Handle
12
13 Lug
14 Hook-shaped projection
15 Securing point
16 Housing
17 First recess
18 Securing means
19 Second recess
20 External securing means
21 Third recess
22 Connecting means
23 Metal ring
24 Opening
25 Opening
26 Additional coatings
27
28 End of external securing means [20]
29 Metal ring
30 Key
31 Bore
32 Rocker switch
33 Upper end of rocker switch [32]
34 Spring
35 Spring
36 Cam disc
37 Lower end of rocker switch [32]
38 Pin
39 Grooves
40 Spring
41 Spring
42 Coding slide
43 Coding slide
44 Key
45 Bore
46 Bore
47 Anchoring point
48 Securing means
49 Securing point
50 Securing means
51 Connecting means
52 External securing means
53 Locking part
54 Handle
55 Compatible elements
56 Housing
57 First recess
58 Second recess
59 First bracket
60 Second bracket
61 Opening region
62 Angle lever
63 Point
64 Opening region
65 Angle lever
66 Point
67 Long limb
68 Long limb
69 Short limb
70 Short limb
71 Pin
72 Pin
73 Arc-shaped recess
74 Arc-shaped recess
75 Locking device
76 Pin
77 Introduction opening
78 Introduction opening
79 Recess
80 Transition region
81 Transition region
82 Insert
83 Insert
84 End
85 End
86 Element
87 Element
88 End
89 End

1. (canceled)

2. Fall prevention system, comprising:
a securing means which runs at least between a first anchoring point and a second anchoring point for a base, a mobile securing point is arranged on the securing means, the mobile securing point being locked with respect to the securing means, the mobile securing point being connected to an object by means of a connecting means and the object is a person, a load, a safety harness, a safety belt or a safety vest, an additional external securing means arranged approximately at an anchoring point, the additional external securing means being connected fixedly to the base with one end and fixedly to a locking part with the other end, the locking part corresponds with a locking unit of the mobile securing point, and unlocking of the mobile securing point with respect to the securing means can only be achieved by attaching the locking part, wherein a locked connection exists between the mobile securing point and the locking part after the unlocking of the connection between the securing means and the mobile securing point.

3. Fall prevention system according to claim 2, wherein the mobile securing point is a unit which surrounds the securing means, which can be opened in at least one part region to produce the connection to the securing means, which has a locking unit which can only be unlocked by connection to a corresponding additional external securing means, wherein the surrounding unit cannot be opened if the additional external securing means is absent and can be opened after the additional external securing means has been attached, and at the same time a lock of the additional external securing means is present when the surrounding unit is opened, which prevents the said securing means from being removed.

4. Fall prevention system according to claim 3, wherein the unit which surrounds the securing means is a carabiner hook, and the locking unit affects the movement of the closure and/or the closure clamping device of the carabiner hook, wherein the locking unit is a component of the carabiner hook and the additional external securing means which is to be attached acts as a key for unlocking and for securing.

5. Fall prevention system according to claim 3, wherein the mobile securing point is a circular or oval unit, with a polygonal outline or approximately rectangular configuration, in which at least one recess which can be opened and one recess which cannot be opened are arranged, wherein the recess which can be opened is used for accommodating the securing means, and the recess which can't be opened is used for attaching a connecting means, wherein a locking unit is arranged in the unit, which corresponds with a closure part of the recesses which can be opened and with an external key.

6. Fall prevention system according to any one of claims 2 to 5, wherein the mobile securing point bears the locking unit, and the locking and/or unlocking takes place by means of a mechanical and/or magnetic and/or electrical and/or radio signal-coded key.

7. Fall prevention system according to claim 2, wherein the connecting means is a rope, a chain, a belt or a loop.

8. Fall prevention method, with a fall prevention system, in which a securing means runs at least between a first anchoring point and a second anchoring point for a subsurface, a mobile securing point is arranged in a movable manner on the securing means, the mobile securing point is connected and locked to an object by means of a connecting means and the object is a person, a load, a safety harness, a safety belt or a safety vest, the mobile securing point can be unlocked with matching means, an additional external securing means is arranged approximately at an anchoring point, the additional external securing means is connected fixedly to the base with one end and fixedly to a locking part with the other end, wherein a mobile securing point is moved by a tensile force acting on the connecting means along the securing means as far as an anchoring point and is prevented by the latter from further movement, an additional external securing means which is arranged approximately at an anchoring point is connected manually to the mobile securing point and in the process the lock between the mobile securing point and the additional external securing means is closed, at the same time as the lock is closed, the lock of the mobile securing point with respect to the securing means is unlocked, the object is in the process prevented from falling by the additional external securing means, the mobile securing point and the connecting means, the mobile securing point is then connected again to a securing means and locked, as a result of which the lock of the mobile securing point with the additional external securing means is unlocked and the connection can be released.

9. Fall prevention method according to claim 8,
comprising an additional step after changing over the mobile securing point to a securing means and closing the recess which accommodates the securing means with a key which is arranged on the securing means, the locking of the mobile securing point with respect to the securing means and the unlocking with respect to the additional external securing means take place.

10. Use of a fall prevention system according to any one of claims 2 or 8 for fall prevention for objects on routes which are provided with a securing means which runs approximately parallel to a base and on which there is a risk of falling for the objects, on buildings and/or on ships and/or on vie ferrate and/or in high rope course and/or in training areas for sporting, mountaineering or military purposes.
